(19) United States
(12) Patent Application Publication
(10) Pub. No.: US 2004/0036675 A1
(43) Pub. Date: Feb. 26, 2004

(54) Method and apparatus for displaying virtual reality space and recording medium recording unit virtual reality space information

(76) Inventor: Chiharu Kajitsuka, Tokyo (JP)

Correspondence Address: JORDAN AND HAMBURG LLP, 122 EAST 42ND STREET, SUITE 4000, NEW YORK, NY, 10168, US

(21) Appl. No.: 10/422,539

(22) Filed: Apr. 24, 2003

(30) Foreign Application Priority Data
Oct. 16, 2000 (JP) 2000-314608

(51) Int. Cl. G09G 5/00

(52) U.S. Cl. 345/156

(57) ABSTRACT

A method for displaying a virtual reality space by using unit virtual reality space information, each of which has information for identifying an adjacent unit virtual reality space, wherein said method comprises steps of detecting user's movement within a reference unit virtual reality space (S6), determining whether adjacent unit virtual reality space information has to be obtained or not according to the detected user's movement (S7), referring to information for identifying adjacent unit virtual reality space included in reference unit virtual reality space information and identifying the adjacent unit virtual reality space information to be obtained (S8), and obtaining the identified adjacent unit virtual reality space information (S9).

### BACKGROUND OF THE INVENTION

1. Field of the Invention

The present invention relates to a method and an apparatus for displaying a virtual reality space by using a unit virtual reality space and a computer-readable recording medium recording a unit virtual reality space. More specifically, the present invention relates to a technique, which enables a user to access a database with a two-dimensional or three-dimensional spatial structure on at least one or more servers via a network such as Internet and have two-dimensional or three-dimensional virtual reality space data to be read in and viewed without interrupting a process of displaying a virtual reality space to the user in principle, by obtaining necessary unit virtual reality space information according to movement of the user's position within the virtual reality space.

2. Description of the Related Art

The main of prevalent methods for viewing graphical data on Internet is an approach to view a document conforming to HTML format by using a Web browser such as “Internet Explorer” or “Netscape Navigator”. In this approach, information available on a network is composed of pages like a book.

For a user to move from one web page to another web page with a browser, the user clicks on a “link”-specified “button”, “text”, “image” or the like placed on a Web page by using, for example, a pointing device. In response to this action, the Web browser requests a predetermined Web server to read in a Web page specified by the link. The Web server responds to the request by obtaining the specified Web page and sending the page to the Web browser. In this manner, the next Web page is displayed via a network by the browser for the user to view it.

### SUMMARY OF THE INVENTION

However, in this method, a user is obliged to suspend his/her work and wait while data of the next page is read in. Especially, when a user moves within a virtual reality space made up with a plurality of Web pages and interruption due to reading occurs while the user moves between the Web pages, the user cannot smoothly move within the virtual reality space, which substantially deprives a user of comfortable operability.

The present invention intends to enable a user to smoothly move within a virtual reality space without forcing the user to wait during data-reading by estimating data necessary to be read in from the user's movement and previously reading the data in.

In order to solve the above problem, the present invention intends to implement a technique for providing a virtual reality space, which enables a user to smoothly move within the virtual reality space by employing the approaches below.

(1. The Invention Described in Claim 1)

The invention described in claim 1 is a method for displaying a virtual reality space by using a plurality of pieces of unit virtual reality space information, each of which has information for identifying an adjacent unit virtual reality space, wherein said method includes the steps of obtaining information for identifying an adjacent unit virtual reality space from reference unit virtual reality space information, and obtaining unit virtual reality space information on the basis of the obtained information for identifying an adjacent unit virtual reality space.

According to the invention, a virtual reality space is subdivided into unit virtual reality spaces, each of which has an appropriate amount of data for a computer to read easily. This enables two-dimensional or three-dimensional virtual reality space data to be read in and viewed without interrupting a process of displaying the virtual reality space to the user by estimating and obtaining unit virtual reality space data, which is expected to be a new display object, according to the user's movement within the virtual reality space.

(2. The Invention Described in Claim 6)

The invention described in claim 6 is an apparatus for displaying a virtual reality space by using a plurality of pieces of unit virtual reality space information, each of which has information for identifying an adjacent unit virtual reality space, wherein said apparatus includes adjacent unit virtual reality space information obtaining means for obtaining information for identifying an adjacent unit virtual reality space from reference unit virtual reality space information on the basis of a user's position within a virtual reality space, and unit virtual reality space information obtaining means for obtaining unit virtual reality space information on the basis of information for identifying the obtained adjacent unit virtual reality space.

According to the invention, a virtual reality space is subdivided into unit virtual reality spaces, each of which has an appropriate amount of data for a computer to read easily. This enables two-dimensional or three-dimensional virtual reality space data to be read in and viewed without interrupting a process of displaying the virtual reality space to the user by estimating and obtaining unit virtual reality space data, which is expected to be a new display object, according to the user's movement within the virtual reality space.

(3. The Invention Described in Claim 11)

The invention described in claim 11 is a computer-readable recording medium, which records unit virtual reality space information for creating a virtual reality space, wherein the unit virtual reality space information has information for identifying a unit virtual reality space adjacent to the unit virtual reality space.

According to the invention, unit virtual reality spaces, each of which has an appropriate amount of data for a computer to read easily, can make up a boundlessly vast virtual reality space. The present invention also enables two-dimensional or three-dimensional virtual reality space data to be read in and viewed without interrupting a process of displaying the virtual reality space to the user by estimating and obtaining unit virtual reality space data, which is expected to be a new display object, according to the user's movement within the virtual reality space.

### BRIEF DESCRIPTION OF THE DRAWINGS

FIG. 1 is a diagram showing an example of two-dimensional virtual reality space;

FIG. 2 is a diagram showing an example of three-dimensional virtual reality space;

FIG. 3 is a conceptual diagram showing how data is read in as an initial state of a two-dimensional virtual reality space;

FIG. 4 is a conceptual diagram showing how data is read in as an initial state of a three-dimensional virtual reality space;

FIG. 5 is a conceptual diagram of a two-dimensional virtual reality space made up with a plurality of square unit virtual reality spaces;

FIG. 6 is a conceptual diagram showing an example of a network system including an apparatus for displaying a virtual reality space according to the present invention;

FIG. 7 is a diagram showing a portion of a virtual reality space made up with cubic unit virtual reality spaces;

FIG. 8 is a flowchart showing processes between a client and a server in a method for displaying a virtual reality space;

FIG. 9 is a conceptual diagram for illustrating a method for deciding unit virtual reality space data to be read in according to a moving direction within a two-dimensional virtual reality space;

FIG. 10 is a diagram showing an exemplary description of a unit virtual reality space;

FIG. 11 is a conceptual diagram for illustrating a manner of deciding unit virtual reality space data to be read in based on bias of user's position;

FIG. 12 is a diagram showing data on which unit virtual reality space is read in when a user's position moves from Block e to Block a in the example of FIG. 11; and

FIG. 13 is a functional block diagram of a client.

### DETAILED DESCRIPTION OF THE PREFERRED EMBODIMENTS

Embodiments of the present invention will be described below with reference to diagrams.

A fundamental concept in illustrating the present invention will be described first.

A database, which stores data for creating a virtual reality space and accessed by a user, is designed as an image-displaying type database for a virtual two-dimensional plain space or a virtual three-dimensional cubic space. Each of various objects such as a text, a still image, a moving image, sound, and a button for each operation is placed in a given position within the virtual reality space, which is defined as a two-dimensional or three-dimensional coordinate. A user occupies a position within the virtual reality space and can move within the virtual reality space. As the user moves, the user receives incessantly varying image information according to the movement from a display device such as a CRT, a liquid display device and the like.

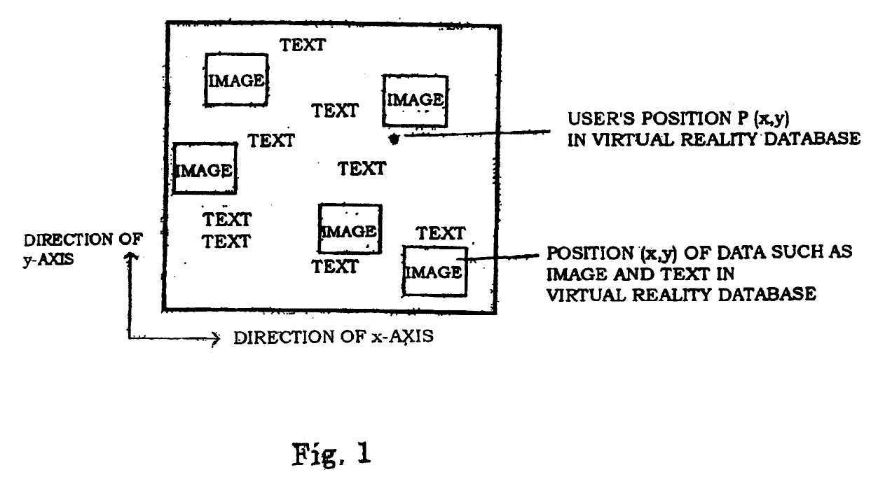

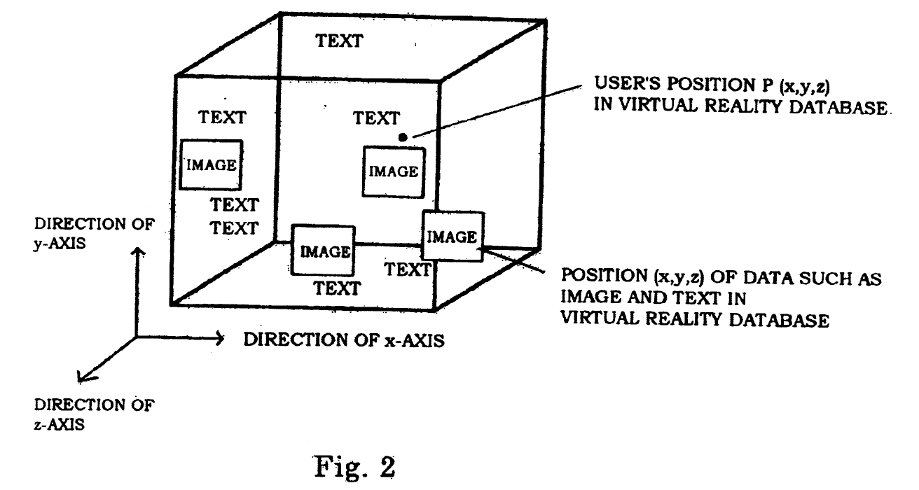

FIGS. 1 and 2 are diagrams showing examples of two-dimensional and three-dimensional virtual reality spaces, respectively.

A position where a user is within a virtual reality space is called “user's position”. A “user's position” is described by two-dimensional coordinates (x, y) in a two-dimensional virtual reality space and by three-dimensional coordinates (x, y, z) in a three-dimensional virtual reality space. An object's position provided within a virtual reality space is also described by two-dimensional coordinates (x, y) in a two-dimensional virtual reality space and by three-dimensional coordinates (x, y, z) in a three-dimensional virtual reality space.

A user is assumed to be in a given “user's position” specified by the user or a server in an initial state. This position is considered to be a “user's position in an initial state”.

The above “user's position” is indicated to a user in the following manner. In a two-dimensional plain space, a “user's position” is indicated to a user by displaying a pointer on a screen or by displaying the user's position as in the center of a display area on a display device. In a three-dimensional space, a “user's position” is indicated to a user by displaying an image viewed from the “user's position” within a virtual reality space on a display device or by displaying a pointer or an avatar within a virtual reality space.

In an initial state, only part of data on a space peripheral to a user's position instead of data on an entire virtual reality space is read into a storage device of a client (i.e., an information processor used by a user. The same terminology is used hereinafter.). This part to be read in is data on a virtual reality space with a given region centering around a “user's position in an initial state”. The size of a given region is determined according to physical limitation such as capacity of a storage device and ability of a display of a client.

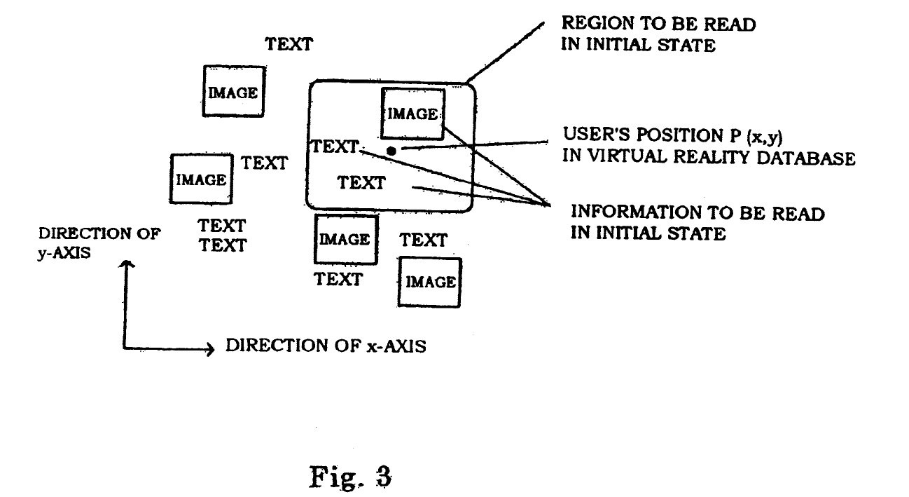

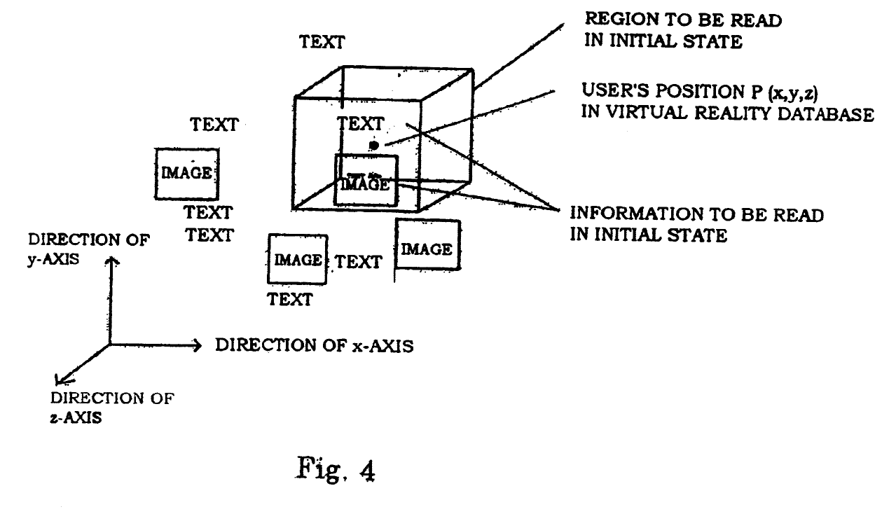

FIGS. 3 and 4 are conceptual diagrams, each of which shows how data is read in as an initial state of a virtual reality space. FIG. 3 shows the case of a two-dimensional space, and FIG. 4 shows the case of a three-dimensional space.

As a “user's position” P within a virtual reality space is displayed to move according to the user's instruction, the user feels as if he/her himself/herself actually moves in the virtual reality space. In this case, the user instructs how to move the user's position P by using various input devices such as a mouse, a keyboard, and a joystick. For example, a user performs an instruction of movement by moving a pointer, by specifying a direction of movement with a cross key or a joystick, or by moving a scroll bar on a screen to scroll the entire screen.

If a user moves in a given direction to a point that meets a certain condition, a client outputs to a server storing data for creating a virtual reality space an instruction to read in data on a space that is set as the destination of the user's movement.

In the present invention, a virtual reality space is created by placing a plurality of unit virtual reality spaces so that the spaces will be adjacent to each other. A “unit virtual reality space” refers to a region of a minimum unit for reading used in displaying a virtual reality space to a user.

Data on a virtual reality space that has read in includes a description of data on sequential unit virtual reality spaces located in respective directions around the space. As an example, a two-dimensional virtual reality space make up by a plurality of square unit virtual reality spaces is considered.

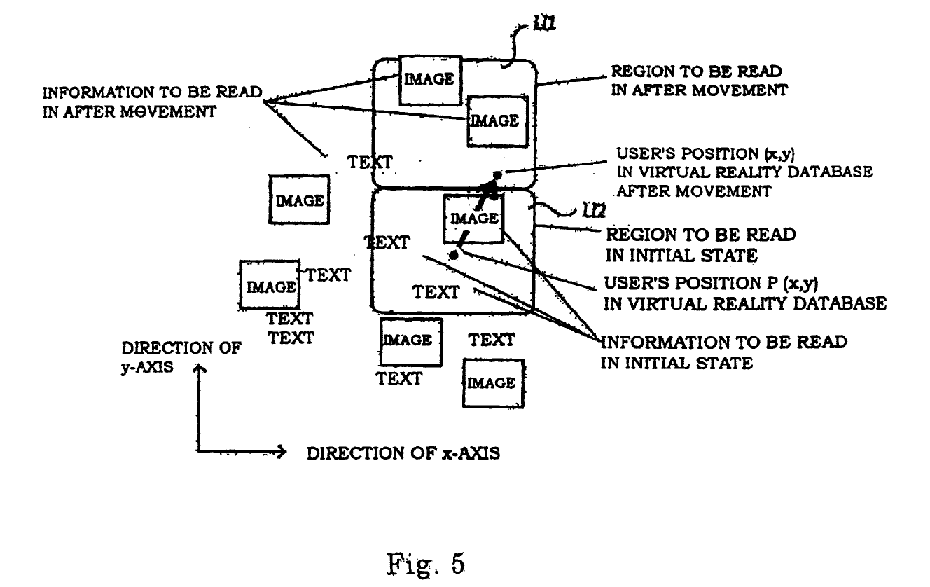

FIG. 5 is a conceptual diagram of a two-dimensional virtual reality space made up with a plurality of square unit virtual reality spaces. In FIG. 5, a square unit virtual reality space U1 corresponding to a user's position in an initial state is read in a client. A unit virtual reality space including a user's position is considered as a “reference unit virtual reality space”. A header of data on unit virtual reality space U1 includes a description of a file name for each unit virtual reality space adjacent to the unit virtual reality space. In the example shown in FIG. 5, a file name for each of nine unit virtual reality spaces, which are sequential to unit virtual reality space U1 in nine respective directions, such as upward, downward, to the left, to the right, slanting upward or slanting downward from U1 is described. A unit virtual reality space adjacent to a certain unit virtual reality space is considered as an “adjacent unit virtual reality space”. The term adjacent means the relationship between one unit virtual reality space and the other unit virtual reality space, where either can be directly moved to the other without passing another unit virtual reality space. In FIG. 5, only an adjacent unit virtual reality space U2, which is on the surface of the diagram, is shown, omitting other adjacent unit virtual reality spaces among nine adjacent unit virtual reality spaces around the unit virtual reality space U1.

When a user moves on within a virtual reality space and a given condition is met, a client refers to file names of adjacent unit virtual reality spaces included in unit virtual reality space U1 and requests a server to read in data on a unit virtual reality space that is estimated to be needed. Continuity between virtual reality spaces is only considered to be in the virtual reality space other than in an actual space. Thus, each of unit virtual reality spaces adjacent to each other in a virtual reality space can be held in a server at a different location. According to a condition, unit reality spaces adjacent to each other can be different. For example, a unit virtual reality space where a user visits can be a different space than before.

In this case, a data-reading process for data on a new unit virtual reality space is preferably performed in parallel with another process such as of moving a user within a virtual reality space or continuously displaying a virtual reality space. This can prevent user's work from interrupted while data is read in. In an example of FIG. 5, if a user's position P approaches adjacent unit virtual reality space U2, a client estimates that data on unit virtual reality space U2 will be required, and requests a server to send the data on unit virtual reality space U2.

In parallel with reading data on a new unit virtual reality space, data on a space, which is no longer needed to be displayed on a screen (data on a space in the opposite direction to the user's moving direction), is preferably discarded or deleted from a storage device of a client according to the user's movement.

With the above operations repeated according to the movement of the user's position, a user feels as if he/her is in a boundlessly wide virtual two-dimensional or three-dimensional space including vast amount of information exceeding capacity of a storage device of a client.

[An Exemplary System Configuration]

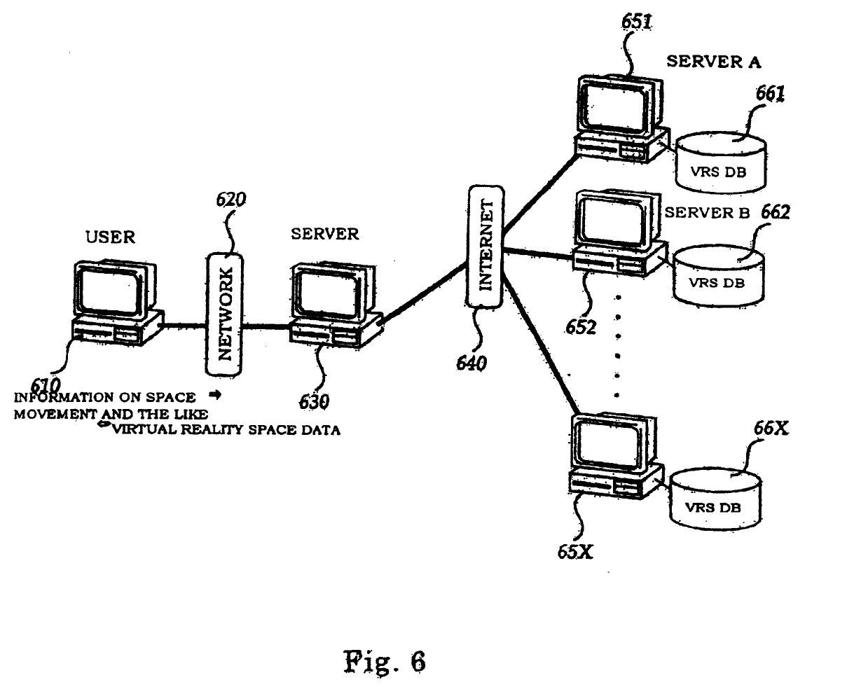

FIG. 6 is a schematic view of a network system including a device for displaying a virtual reality space according to the present invention.

The system includes two-dimensional or three-dimensional databases 661, 662, . . . , and 66X separately held in a storage device of at least one of servers 651, 652, . . . , and 65X, and a user's-side terminal (hereinafter referred to as a “client”) 610 that can access to the databases via network 620, server 630, and Internet 640. The term user means one who uses a virtual reality space.

Client 610 is connected with server 630 via network 620 such as a LAN. Client 610 is in a configuration that a user accesses over the server 630 to another servers 651, 652, . . . , and 65X connected to the server 630 via network 640. Server 630 that is directly accessed by a user is not necessarily one for storing data on a virtual reality space, and may be anyone that can inform another server of an instruction from a client. Connection between a client and a server is not limited to this way and any connection that enables intercommunication can be used.

Client 610 is preferably one that can perform a process of data-reading and such a process of moving a position or displaying a screen according to a user's request. For example, a client may be configured by using a computer including a multitasking OS (e.g., Windows from Microsoft (registered trademark) or UNIX) or a computer with a processing speed enough for an application for displaying a virtual reality space to perform a plurality of processes.

(1. Holding of a Virtual Reality Space Database)

(1. 1. Unit Virtual Reality Space)

The above-mentioned virtual reality space databases 661, 662, . . . , and 66X are designed by being subdivided into limited data spaces according to physical limitation of an entire system. Each of the subdivided data spaces is also a basic unit in outputting an instruction for reading from a client to a server. The data space that is a basic unit in outputting an instruction for reading from a client to a server is referred to as a “unit virtual reality space”.

A “unit virtual reality space” includes data on such an image or a text to be displayed within a data space, and a coordinate where they are placed.

In the present invention, data that associates a piece of image data or text data with a coordinate of its position can also be considered as a “unit virtual reality space”. In efficiency of data-reading or database management, it is preferable to use a file defined to include a data space of a certain size that can store an image or a text as a “unit virtual reality space”.

Any shape can be used for a “unit virtual reality space” within a region that can be described mathematically. For example, a shape of a unit virtual reality space used in a two-dimensional virtual reality space may be a hexagon instead of a square, and a shape of a unit virtual reality space used in a three-dimensional virtual reality space may be a tetrahedron or an octahedron instead of a cube. In the following description, a square is taken for a two-dimensional space and a cube is taken for a three-dimensional space as the easiest specific examples.

In each “unit virtual reality space”, which unit virtual reality spaces are adjoining around the “unit virtual reality space” is described.

A unit virtual reality space has a width of a space described with x-y coordinates for a two-dimensional virtual reality space, and a width of a space described with x-y-z coordinates for a three-dimensional virtual reality space. The embodiment is described as using an orthogonal coordinate system as a coordinate system to represent a position of a virtual reality space or position of an object therein, though other coordinate systems can be used.

When a vast virtual reality space as a collection of “unit virtual reality spaces” is considered, data in each unit virtual reality space needs not to be described with a single unified collection of coordinate axes (absolute coordinate). This will be described below with an example of a virtual reality space made up with cubic unit virtual reality spaces.

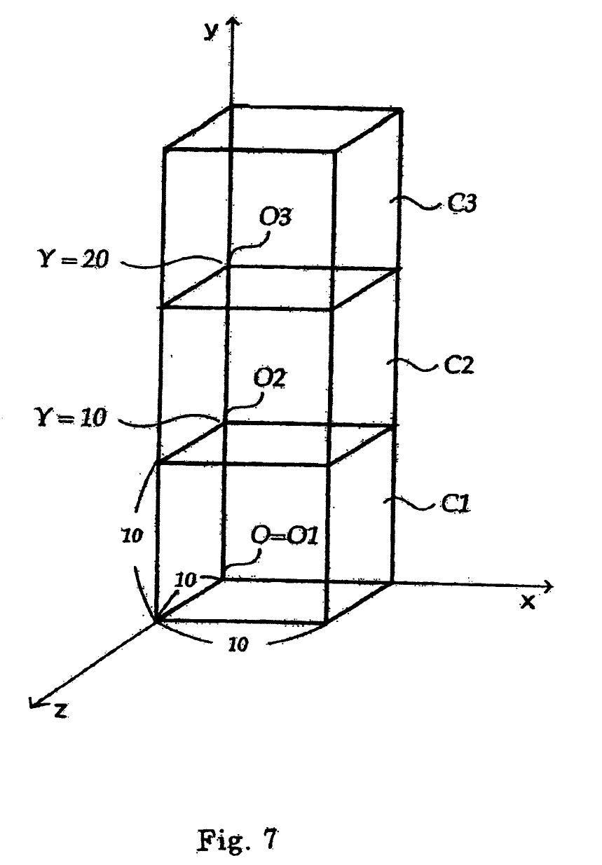

FIG. 7 is a diagram showing a portion of a virtual reality space made up with cubic unit virtual reality spaces.

In FIG. 7, a unit virtual reality space C1 in a shape of a cube and a size of (10×10×10) is defined that one of its corners O1 is located at an origin O (x=0, y=0, z=0). Unit virtual reality space C2 in the same size is defined as adjacent to the upside of the cubic data space. Another cubic unit virtual reality space C3 is defined on the upside of the unit virtual reality space C2.

Here, the second unit virtual reality space C2 is placed as one of its corners O2 is placed at x=0, y=10, and z=0, and the third unit virtual reality space C3 is placed as one of its corners O3 is placed at x=0, y=20, and z.0. Each of unit virtual reality spaces C1, C2, and C3 has an image or a text.

If a coordinate position of an object such as an image or a text included in each of the unit virtual reality spaces C1, C2, and C3 is described by integrating it into an absolute coordinate that based on the above-mentioned origin O (x=0, y=0, z=0), the larger the virtual reality space, a coordinate may have a too large value for a computer to process as a virtual reality space become larger.

Therefore, in the present invention, a coordinate position of an object such as an image or a text included in each of the unit virtual reality spaces is defined with a coordinate for each unit virtual reality space (hereinafter referred to as a “unit virtual reality space coordinate”). For example, an object within unit virtual reality space C1 is represented with a coordinate where a reference point O1 of C1 is considered as an origin, and an object within unit virtual reality space C2 is represented with a coordinate where a reference point O2 of C2 is considered as an origin.

Continuity for respective unit virtual reality spaces, such as a certain unit virtual reality space is located at the distance 20 from another unit virtual reality space, is described in each unit virtual reality space information data, but the continuity for respective unit virtual reality spaces is not defined by using an absolute coordinate axis or a common coordinate axis.

On the other hand, after a plurality of “unit virtual reality spaces” are read in a client, the spaces are re-mapped in a local coordinate in the client for using.

(1. 2. Holding Data in a Server)

Each of virtual reality space databases 661, 662, . . . , and 66X shown in FIG. 6 holds data for constructing a virtual reality space in a form that enables reading in units of a “unit virtual reality space”.

(1. 3. A Flow of Processes After a Client Accessed a Server)

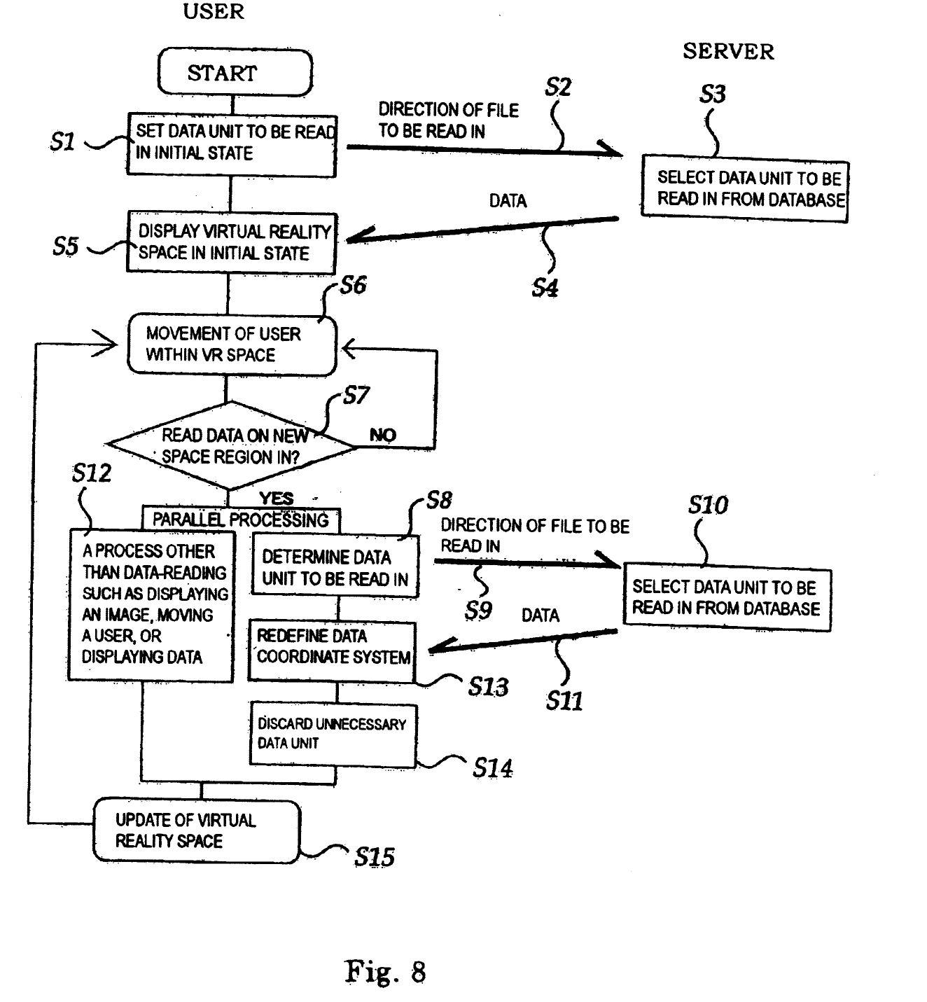

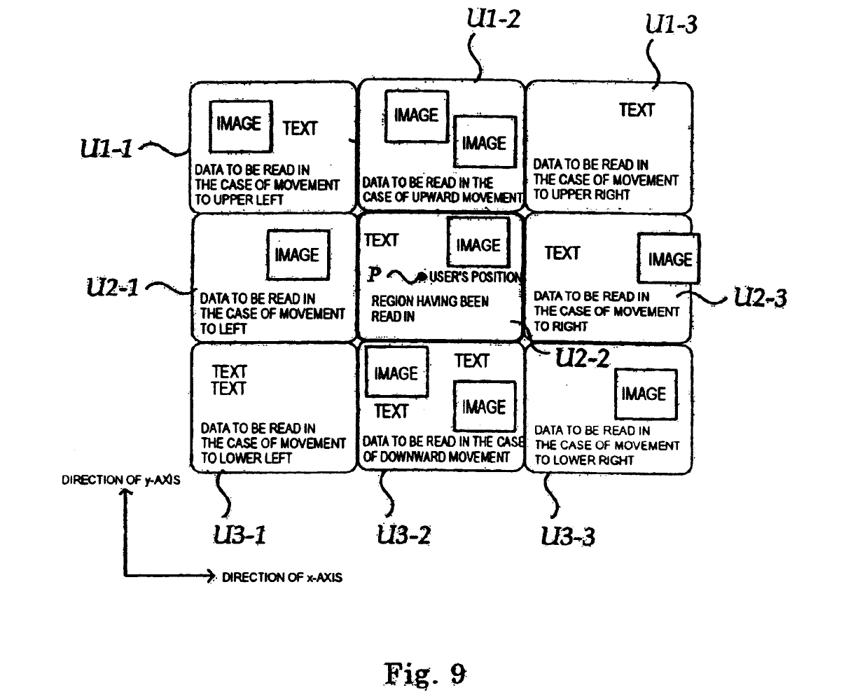

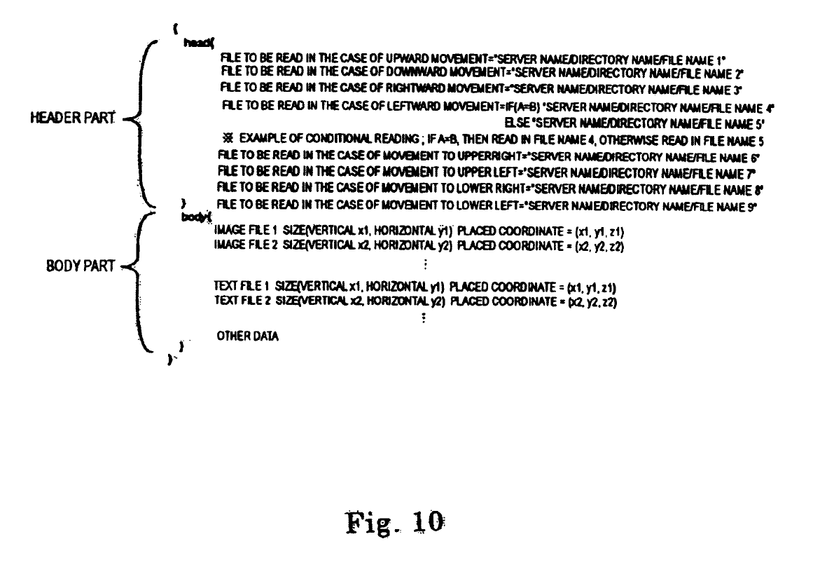

Next, processes for obtaining data for a client to obtain and display a virtual reality space in units of a unit virtual reality space and will be described with reference to FIGS. 8 to 11. FIG. 8 is a flowchart showing processes between a client and a server according to the embodiment. FIG. 9 is a conceptual diagram for illustrating data-reading according to movement of a “user's position” in a two-dimensional virtual reality space. FIG. 10 is a diagram showing an example of how data is described in a unit virtual reality space.

(1.3.1 Data-Reading from a Client in an Initial State)

A client first defines a unit virtual reality space to be read in an initial state (S1 in FIG. 8). The term initial state means a state where reading of unit virtual reality space data for making up a virtual reality space is not started. A unit virtual reality space to be read in an initial state maybe previously defined in a client or a server. The client requests a collection of servers via a network to send data corresponding to the defined unit virtual reality space (S2). Then, information on the “unit virtual reality space” (e.g., a file name of a file including a unit virtual reality space or a URL where the file is recorded) is sent to a collection of servers via a network and the like.

In response to this request, the collection of servers (more specifically, among the collection of servers, a server that has data on the unit virtual reality space) obtains data on the unit virtual reality space from the virtual reality space database (S3), and sends it to the client (S4).

Next, the client reads the data on a “unit virtual reality space” that was first read in and requests the server to read in data on “adjacent unit virtual reality spaces” adjoining the “unit virtual reality space”. According to the request, a plurality of data spaces are read in from a collection of servers. Data on “adjacent unit virtual reality spaces” is not necessarily obtained. In implementing the present invention, it may be enough to read in only the defined “unit virtual reality spaces” depending on a physical condition such as memory capacity of a client.

The process of reading adjacent unit virtual reality spaces in can be omitted. In order to provide a user with a process of smoothly displaying virtual reality spaces so that the user does not perceive the data-reading, a plurality of unit virtual reality spaces, instead of only a single unit virtual reality space, preferably have always been read in. A client has to include data spaces according to a display capability or storage capacity of the client. By considering the included data space to be made up with a plurality of unit virtual reality spaces instead of a single data space; for example, by considering that it is made up with 27 “unit virtual reality spaces” for a cube, or that it is made up with nine “unit virtual reality spaces” for a square, a data size for each “unit virtual reality space” can be reduced. The smaller the size of data is, the lighter the load in transferred via a network.

By additionally reading in some unit virtual reality spaces to extend a data space in the direction and by discarding a unnecessary unit virtual reality space from a storage device of a client, load on a client can be reduced because no process of displaying an image is performed for a unit virtual reality space that has nothing to do with the display concerned.

Next, the client replaces a coordinate of a data space of a read in “unit virtual reality spaces” or more with a local coordinate of the client and displays the virtual reality space on the basis of the new coordinate (S5). For example, if a plurality of “unit virtual reality spaces” are read in, a position of an object such as an image or a text located in each space is described with each unit virtual reality space coordinate, as mentioned above. In order to display a coordinate position of an object described with each unit virtual reality space coordinate within a single continuous virtual reality space, the coordinate position is replaced with a unified coordinate for displaying.

A virtual reality space has been displayed in an initial state.

(1.3.2. Reading of a “Unit Virtual Reality Space” According to User's Movement)

After a virtual reality space has been displayed in an initial state, a “unit virtual reality space” in the direction of user's movement has to be read in according to the user's movement within a virtual reality space before the user moves out of the data space that already has been read.

However, a user has to wait for data on a new unit virtual reality space to be read in if the new unit virtual reality space starts to be read in when the user reaches an edge of a data space that already has been read.

Thus, detect the direction of the user's movement (S6), and determine whether data on the new unit virtual reality space has to be read in or not (S7). Determine the unit virtual reality space where the user is about to enter, if needed (S8), and request a collection of servers via a network to send necessary data on a unit virtual reality space on the basis of the determination (S9). At this moment, information on the “unit virtual reality space” is sent to a collection of servers via a network and the like.

In response to this request, the collection of servers (more specifically, among the collection of servers, a server that has data on the unit virtual reality space) obtains data on the unit virtual reality space from the virtual reality space database (S10) and sends it to a client (S11).

As reading of data has started, it does not need to wait for the data to be read in.

Determination of the direction of user's movement may be based on a direction in which the user is biased within a unit virtual reality space including the user's position and on a vector of the movement direction that is indicated by the user.

Determination manners vary by capacity of a client. The present invention can be implemented with any manner. A manner of looking ahead the direction of user's action with an artificial intelligence may be used. Here, a manner with light processing, which can be implemented easily is described as an example.

First, a manner of detecting the movement direction of a user's position and deciding unit virtual reality space data to be read in based on the movement direction will be described.

FIG. 9 is a conceptual diagram for illustrating a method for deciding unit virtual reality space data to be read in according to a movement direction within a two-dimensional virtual reality space.

In this example, unit virtual reality space U2-2, which is the only unit virtual reality space that a client has read in, is a reference unit virtual reality space including user's position P. Adjacent unit virtual reality spaces to the reference unit virtual reality space are U1-1, U1-2, U1-3, U2-1, U2-3, U3-1, U3-2, and U3-3, which have not been read in.

A unit virtual reality space stores a description that indicate to read which data on an adjacent unit virtual reality space if user's position P moves in which direction. For example, there is a description that indicates to read unit virtual reality space U1-1 if user's position P moves to upper left. There are also directions for other seven directions.

FIG. 10 is a diagram showing an exemplary description of unit virtual reality space U2-2. The header part includes a description of the above-mentioned relation between a movement direction and a unit virtual reality space to be read in. The body part includes a description of a file name, a size, and coordinate values represented by unit virtual reality coordinates for an object to be placed within the unit virtual reality space. Likewise, for data on all other unit virtual reality spaces, the header part includes a description of the above-mentioned relation between a movement direction and a unit virtual reality space to be read in, while the body part includes a description concerning an object to be placed within the unit virtual reality space.

In the exemplary description, the header part and the body part are described in a single data file together. However, a header part and a body part are not necessarily described in a single file. A header part and a body part may be described separately in two files, taking consideration of program efficiency or data storage efficiency. In this case, a file name of a corresponding body part is described in a file of a header part. It is also possible that each file of a header part and a body part is described with further divided into a plurality of files, if needed. In such a case, collections of files with correspondence each other collectively describe a single unit virtual reality space.

Next, another example of a manner of deciding unit virtual reality space data to be read in based on user's movement will be described.

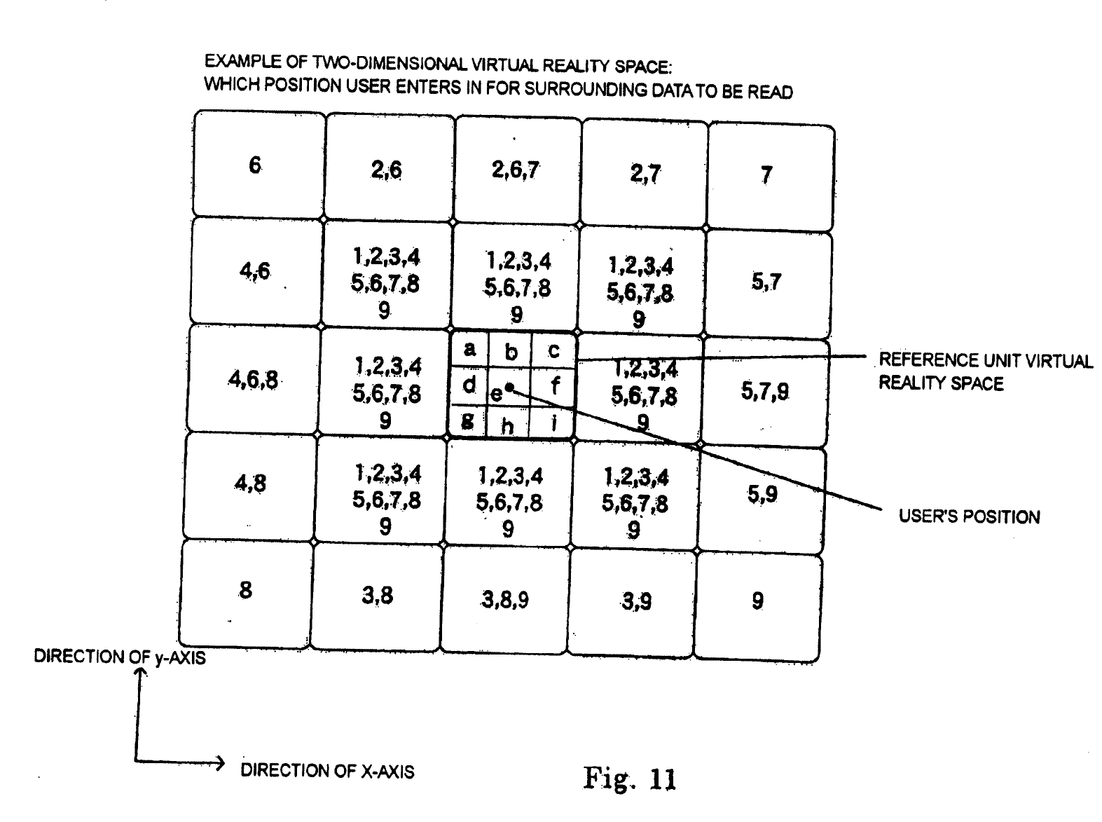

FIG. 11 is a conceptual diagram for illustrating a manner of deciding unit virtual reality space data to be read in based on bias of user's position. In this example, a virtual reality space made up with square “unit virtual reality spaces” will be considered. The “unit virtual reality spaces” is subdivided into nine square regions a to i (every square region is referred to as a “block for determining a user's position”). A square region in the figure represents a unit virtual reality space. A number described in each square region has following meaning.

The number “1” indicates that it is one of nine unit virtual reality spaces having read in as an initial condition and also it is a unit virtual reality space that should have been read in when a user's position is in Block e. The number “2” indicates that it is a unit virtual reality space that should have been read in when a user's position is in Block b. The number “3” indicates that it is a unit virtual reality space that should have been read in when a user's position is in Block h. The number “4” indicates that it is a unit virtual reality space that should have been read in when a user's position is in Block d. The number “5” indicates that it is a unit virtual reality space that should have been read in when a user's position is in Block f. The number “6” indicates that it is a unit virtual reality space that should have been read in when a user's position is in Block a. The number “7” indicates that it is a unit virtual reality space that should have been read in when a user's position is in Block c. The number “8” indicates that it is a unit virtual reality space that should have been read in when a user's position is in Block g. The number “9” indicates that it is a unit virtual reality space that should have been read in when a user's position is in Block i.

User's position P must be in one of the nine “blocks for determining a user's position”. Which “block” the user's position P is in is easily determined from x-y-z coordinates of the user's position.

No instruction to read a new data occurs while user's position P is moving within a “block for determining a user's position”. An instruction to read occurs when user's position P moves from a “block for determining a user's position” to another “block for determining a user's position” according to a movement.

Each “block” is defined that which of surrounding “unit virtual reality spaces” should have been read in when a user's position is in the “block”.

When user's position P moves from a block (hereinafter referred to as “Block A”) to another block (hereinafter referred to as “Block B”) according to the movement of the user's position P, the difference between a collection of cubes of surrounding “unit virtual reality spaces”, which should have been read in when a user's position is in Block A, and a collection of cubes of surrounding “unit virtual reality spaces”, which should have been read in when a user's position is in Block B, is a “unit virtual reality space” cube, which further has to be read in according to the movement.

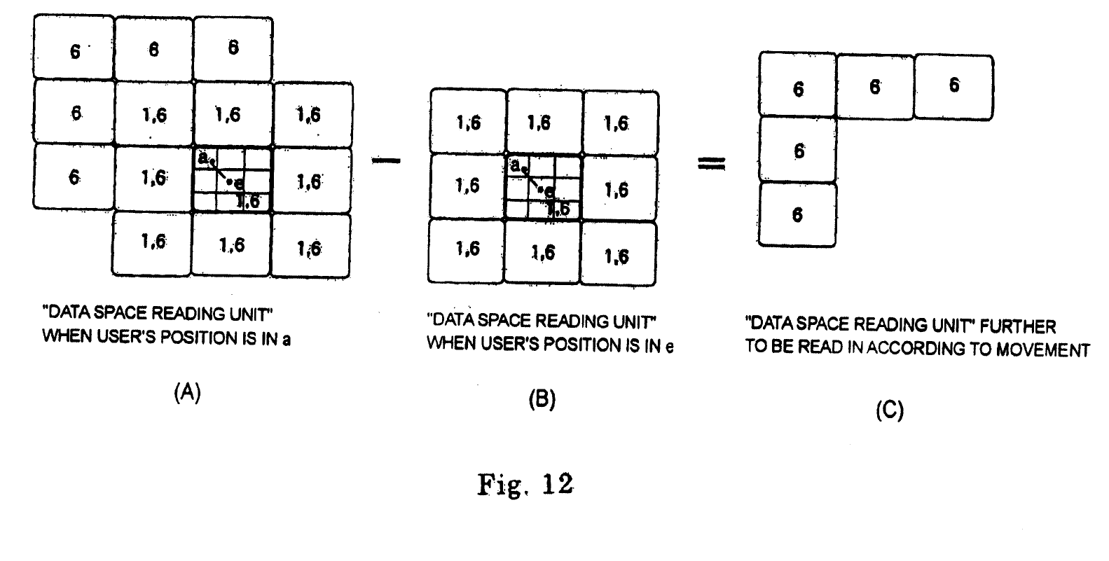

FIG. 12 is a diagram showing data on which unit virtual reality space is read in when a user's position moves from Block e to Block a in the example of FIG. 11.

Character (a) in FIG. 12 indicates a unit virtual reality space that should have been read in when a user's position is in Block a, i.e., a unit virtual reality space that includes “6” in FIG. 11. Character (b) indicates a unit virtual reality space that should have been read in when a user's position is in Block e, i.e., a unit virtual reality space that includes “1” in FIG. 11. As a user's position is in Block e, data on a unit virtual reality space shown in b in FIG. 12 has been read in. Therefore, a unit virtual reality space that further has to be read in can be determined by subtracting a virtual reality space shown in (b) from a virtual reality space shown in (a) ((c) in FIG. 12).

The difference also indicates an unnecessary “unit virtual reality space” cube to be discarded. An actual process of discarding data is performed in the next step.

If it is actually determined only with this manner and a user crosses to and fro over borders among a plurality of blocks, an instruction to read data is frequently output, which may cause slower processing. Thus, in order to determine whether the direction of user's movement is certain or not, it is preferable to take a measure to output an instruction to read after observing the user's movement for a while, instead of outputting a new instruction to read data at the moment that a user moves to another block.

Returning to FIG. 8, the client requests the server to send data on a necessary unit virtual reality space according to a determination such as shown in the above FIGS. 9 to 12 (S9). In response to this request, a collection of servers (more specifically, among the collection of servers, a server that has data on the corresponding unit virtual reality space) obtains data on the unit virtual reality space from the virtual reality space database (S10), and sends it to the client (S11).

After outputting a new request to send a “unit virtual reality space” to the server (S9), the client returns to a process of moving user's position or displaying a screen again (S12). As the client performs a request of a “unit virtual reality space” in a moment, a process of moving user's position or displaying a screen in the client cannot be interrupted. Then, on receiving data on a unit virtual reality space requested, the client reads the data, replaces coordinate data included therein with a local coordinate system of the user (S13), and loads the replaced data into memory. These processes are preferably performed in parallel with a process of moving a user or displaying a screen (S12). Accordingly, a client is preferably a device that can support a multitasking operation.

(1.3.3. Redefining of a Local Data Space Coordinate of a User)

A user keeps on moving inside a local coordinate system, which has been set in a client. A unit virtual reality space read from a server or an object therein is replaced into the local coordinate system and placed in, as mentioned above.

The further the user moves in a virtual reality space, the larger the values in a local coordinate system will be. It is inappropriate for a computer to treat a coordinate value increasing infinitely.

Therefore, it should be sufficient for a local coordinate system to have a necessary size for defining all data spaces that have been read in a client at the same moment by regularly redefining the local coordinate system on the basis of the current position of a user.

In a case where a unit virtual reality space is a cube, a method can be taken for redefining a local coordinate when user's position P moves from a “unit virtual reality space” to a space in an adjacent “unit virtual reality space”.

(1.3.4. Discarding of an Unnecessary “Unit Virtual Reality Space” According to User's Movement)

In the above steps S7 to S13, a “unit virtual reality space” of a new space, to which the user is estimated to move, is read in according to the user's movement. That will hinder a client in its operation as data gradually accumulates in a client, for example in memory of the client.

Therefore, “unit virtual reality space” data in a direction opposite to the movement direction of the user's position, for example, is preferably discarded from a storage device of a client (S14). Timing of discarding depends on storage capacity of a client, but data is preferably held as long as possible. This is because, for example, if a user changes his/her mind and abruptly changes his/her way in the opposite direction for returning, data on spaces ahead him/her needs not to be read in again.

The following manner can be taken as a discarding determination manner.

Determine whether a space in a “unit virtual reality space” is further than a certain distance from the current user's position as the need arises. When it is determined that the space leaves from the current user's position by a sufficient distance, data on the position is discarded. The sufficient distance is defined based on physical limitation (e.g., capacity or screen displaying capability) of a client.

In such a case where a client has small storage capacity, a process of reading in data on a new space and a process of discarding data on an unnecessary space can be performed in inverse order.

Data on a virtual reality space loaded on a storage device of a client in the above-mentioned manner is provided to the user by being subjected to an image generating process with image processing means such as a graphic board and displayed on a given display device such as a CRT or a liquid crystal display (S15).

Thereafter, serial movement of a user can be implemented within a virtual reality space by repeating the above-mentioned processes from S7 to S15 according to the movement of the user's position.

[An Exemplary Configuration of a Client]

Next, an exemplary configuration of client 610 shown in FIG. 6 will be described.

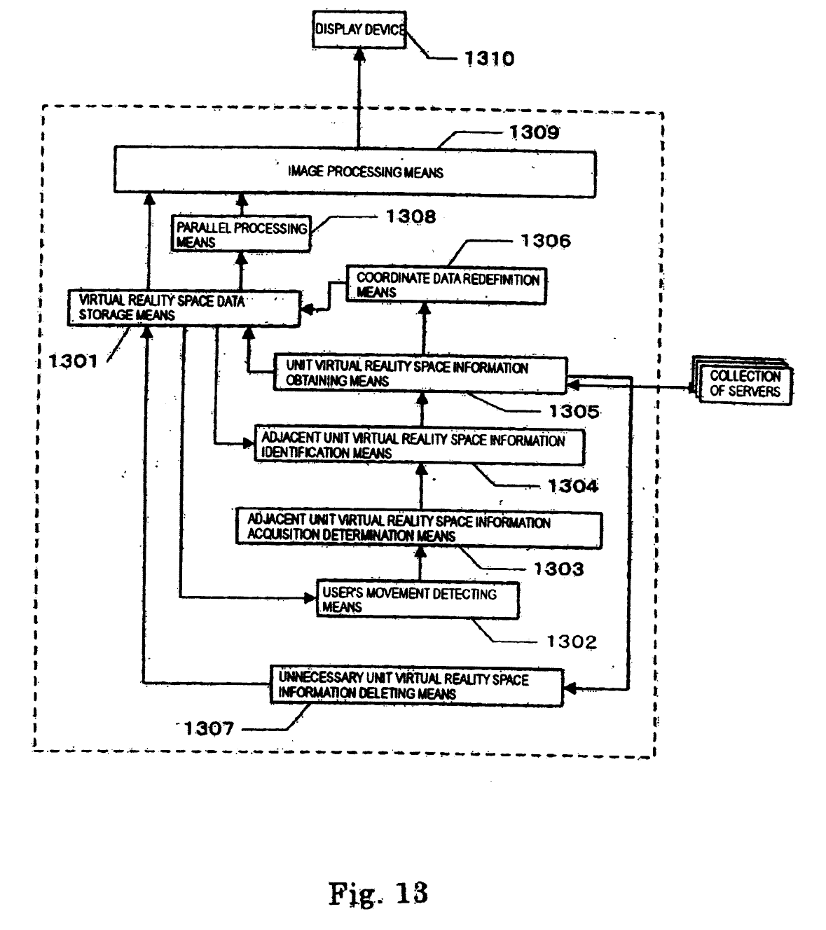

FIG. 13 is a functional block diagram of a client.

A client has virtual reality space data storage means 1301. This storage means 1301, which stores user's position information, cumulatively stores data on a unit virtual reality space received from a server.

User's movement detecting means 1302 obtains user's position information from the storage means 1301 and sends it to adjacent unit virtual reality space information acquisition determination means 1303. The determination means 1303 determines whether any of adjacent unit virtual reality spaces has to be read in or not from the sent user's position information. When it is determined that it has to be read in, the determination means 1303 instructs adjacent unit virtual reality space information identification means 1304 to identify an adjacent unit virtual reality space.

The identification means 1304 received the instruction determines which data on a unit virtual reality space is required according to a predetermined manner and obtains data for obtaining a required unit virtual reality space (e.g., a rout path or a file name for a file storing data on the unit virtual reality space, or when a client is used in a network, a URL of a file storing data on the unit virtual reality space). As data for obtaining the unit virtual reality space is stored in data on a unit virtual reality space, for example in a header part, the data can be obtained by reading the header part.

The data for obtaining a unit virtual reality space is passed to unit virtual reality space information obtaining means 1305. The unit virtual reality space information obtaining means 1305 reads data on a unit virtual reality space to be needed based on the data for obtaining a unit virtual reality space from a storage device storing the data for obtaining a unit virtual reality space, or requests a server to send the data on a unit virtual reality space and receives it.

The unit virtual reality space information obtaining means 1305, which has received the data on a unit virtual reality space, writes this data into storage means 1301 and also instructs coordinate data redefinition means 1306 to rewrite coordinate data in data on a virtual reality space accumulated in the storage means 1301 into a local coordinate of the client. The redefinition means 1306 performs a calculation for this coordinate rewriting, and rewrites data on a virtual reality space accumulated in storage means 1301 on the basis of the calculation result.

The unit virtual reality space information obtaining means 1305, which has received the data on a unit virtual reality space, also instructs unnecessary unit virtual reality space information deleting means 1307 to delete unnecessary data from data on virtual reality spaces accumulated in the storage means 1301 according to the user's movement. The deleting means 1307 deletes the unnecessary data on a unit virtual reality space in units of a unit virtual reality space according to the instruction.

Along with a process of reading the data on unit virtual reality spaces, parallel processing means 1308 performs processes other than reading of data on a unit virtual reality space, such as processing of user's position and passes the result to image processing means 1309.

The image processing means 1309 receives, from storage means 1301, data on a virtual reality space after the replacement of coordinate data and the deletion of the unnecessary virtual reality space.

The image processing means 1309 generates image data by processing data received from parallel processing means 1308 and storage means 1301, and then passes it to display device 1310.

According to the configuration of a client, data that has to be read in has been estimated from user's movement and has previously read in. This enables smooth movement of a user within a virtual reality space without forcing the user to wait while data is read in.

According to the present invention, data on a necessary unit virtual reality space has been read in according to movement of a user's position within a virtual reality space. This enables continuous movement with no interruption within a virtual reality space to be provided to a user without forcing the user to wait while data is read in.

What is claimed is:

1. A method for displaying a virtual reality space by using a plurality of pieces of unit virtual reality space information, each of which has information for identifying each adjacent unit virtual reality spaces, wherein said method comprises the steps of:
obtaining information for identifying each adjacent unit virtual reality space from reference unit virtual reality space information; and
obtaining unit virtual reality space information on the basis of the obtained information for identifying each adjacent unit virtual reality space.

2. A method for displaying a virtual reality space by using a plurality of pieces of unit virtual reality space information, each of which has information for identifying an adjacent unit virtual reality space, wherein said method comprises:
a first step of detecting user's movement within a reference unit virtual reality space;
a second step of determining whether adjacent unit virtual reality space information has to be obtained or not according to the detected user's movement;
a third step of , if it is determined that adjacent unit virtual reality space information has to be obtained, referring to information for identifying adjacent unit virtual reality space included in reference unit virtual reality space information and identifying the adjacent unit virtual reality space information to be obtained;
a fourth step of obtaining the identified adjacent unit virtual reality space information; and
a fifth step of redefining coordinate data for the obtained adjacent unit virtual reality space information.

3. The method for displaying a virtual reality space according to claim 2, wherein the method further comprises a sixth step of performing a process other than data-reading in parallel with at least one of said third step, said fourth step, and said fifth step.

4. The method for displaying a virtual reality space according to claim 3, wherein the method further comprises a seventh step of deleting unnecessary unit virtual reality space information after said fourth step.

5. A computer-readable recording medium recording a program for causing a computer to perform the method described in any of claims 1 to 4.

6. An apparatus for displaying a virtual reality space by using a plurality of pieces of unit virtual reality space information, each of which has information for identifying an adjacent unit virtual reality space, wherein said apparatus comprises:
adjacent unit virtual reality space information obtaining means for obtaining information for identifying an adjacent unit virtual reality space from reference unit virtual reality space information according to a user's position within the virtual reality space; and
unit virtual reality space information obtaining means for obtaining unit virtual reality space information on the basis of the obtained information for identifying an adjacent unit virtual reality space.

7. An apparatus for displaying a virtual reality space by using a plurality of pieces of unit virtual reality space information, each of which has information for identifying an adjacent unit virtual reality space, wherein said apparatus comprises:
user's movement detecting means for detecting user's movement within a reference unit virtual reality space;
adjacent unit virtual reality space information acquisition determination means for determining whether adjacent unit virtual reality space information has to be obtained or not according to the detected user's movement;
adjacent unit virtual reality space information identification means for referring to information for identifying adjacent unit virtual reality space included in reference unit virtual reality space information and identifying adjacent unit virtual reality space information to be obtained, if it is determined that the adjacent unit virtual reality space information has to be obtained;
unit virtual reality space information obtaining means for obtaining the identified adjacent unit virtual reality space information; and
coordinate data redefinition means for redefining coordinate data for the obtained adjacent unit virtual reality space information.

8. The apparatus for displaying a virtual reality space according to claim 7, wherein the apparatus further comprises parallel processing means for performing a process other than data-reading in parallel with a process performed by at least one of said adjacent unit virtual reality space information identification means, said unit virtual reality space information obtaining means, and coordinate data redefinition means.

9. The apparatus for displaying a virtual reality space according to claim 8, wherein the apparatus further comprises unnecessary unit virtual reality space information deleting means for deleting unnecessary unit virtual reality space information after adjacent unit virtual reality space information to be obtained is identified.

10. A computer-readable recording medium recording a virtual reality space-displaying program for causing a computer to configure an apparatus described in any of claims 6 to 9.

11. A computer-readable recording medium recording unit virtual reality space information for creating a virtual reality space;
wherein the unit virtual reality space information has information for identifying unit virtual reality space adjacent to the unit virtual reality space.

12. The computer-readable recording medium according to claim 11, wherein said information for identifying an adjacent unit virtual reality space is an identifier of unit virtual reality space information.
